(19) United States
(12) Patent Application Publication
(10) Pub. No.: US 2007/0058934 A1
(43) Pub. Date: Mar. 15, 2007

(54) Decoding/reproducing apparatus

(76) Inventors: Yuusuke Yamanaka, Kanagawa (JP); Akio Noda, Kanagawa (JP)

Correspondence Address: MCDERMOTT WILL & EMERY LLP, 600 13TH STREET, N.W., WASHINGTON, DC, 20005-3096, US

(21) Appl. No.: 11/499,649

(22) Filed: Aug. 7, 2006

(30) Foreign Application Priority Data
Sep. 12, 2005 (JP) P2005-263742

(51) Int. Cl. H04N 7/00

(52) U.S. Cl. 386/95

(57) ABSTRACT

A decoding/reproducing apparatus is equipped with: a time period setting apparatus 13 for previously setting a time period related to a synchronous control operation; a reproducing time instant detecting means 6 for detecting synchronous reproduction-purpose reproducing time instant information from stored stream data in the time period; a synchronous control apparatus 7 which compares the detected reproducing time instant information with system time instant information, and which instructs to wait for an output in the case that a difference between a reproducing time instant and a system time instant is larger than 0, and is smaller than a preset positive value, and also which instructs to discard output data in the case that a difference between a reproducing time instant and a system time instant is defined within a range of a preset negative value; and output data discarding/output waiting apparatus 4 and 11 for controlling discarding of the output data, or waiting of the output.

### BACKGROUND OF THE INVENTION

1. Field of the Invention

The present invention is related to a decoding/reproducing apparatus for demultiplexing multiplexed stream data produced by an MPEG (Moving Picture Experts Group) system and for decoding and reproducing the respective stream data.

2. Description of the Related Art

In MPEG systems of conventional decoding/reproducing apparatus, synchronous control operations have been carried out by comparing PTS (Presentation Time Stamp) information which has been added to each of demultiplexed stream data with an STC (System Time Clock). At a time instant when STC reaches a time instant of PTS information, output data formed by decoding stream data is reproduced. This comparing operation between the PTS information and the STC has been carried out for every 1 frame of each of the stream data.

Also, in order to perform high-precision synchronous control operation, another decoding/reproducing apparatus has been proposed by which a comparing operation between PTC and STC is repeatedly carried out in a high frequency by employing a timer interrupt function until STC reaches a time instant of PTS (refer to, for example, JP-A-2004-104733 (pages 6 to 11, FIG. 1)).

However, in the above described conventional decoding/reproducing apparatus, since the complex process operation related to the synchronous control operations are carried out for every 1 frame of each of the stream data, there are such problems that a total amount of these process operations is increased, and thus, the above-explained complex process operation cannot be suitably applied to appliances such as portable terminals which are required to suppress processing amounts thereof.

### SUMMARY OF THE INVENTION

The present invention has an object to provide a decoding/reproducing apparatus capable of simplifying synchronous control operation so as to reduce a total amount of processing operations.

A decoding/reproducing apparatus, according to the present invention, is featured by such a decoding/reproducing apparatus for decoding/reproducing multiplexed stream data which is formed by multiplexing a plurality of stream data arranged in the unit of a frame, to which reference time instant information and synchronous reproduction-purpose reproducing time instant information are added, comprising: demultiplexing means for demultiplexing the multiplexed stream data to obtain a plurality of stream data; storage means for storing thereinto the plurality of stream data demultiplexed by the demultiplexing means; decoding means for decoding the stream data stored in the storage means in the unit of the frame; output means for outputting output data decoded by the decoding means in the unit of the frame; time period setting means for previously setting a time period related to asynchronous control operation; reproducing time instant detecting means for detecting the synchronous reproduction-purpose reproducing time instant information from the stream data stored in the storage means in the time period; system time instant measuring means for measuring a system time instant based upon the reference time instant information; synchronous control means which compares the reproducing time instant information with the system time instant information measured by the system time instant measuring means, and which instructs to wait for an output in the case that a difference between a reproducing time instant and a system time instant is larger than 0, and is smaller than a preset positive value, and also which instructs to discard output data in the case that a difference between a reproducing time instant and a system time instant is defined within a range of a preset negative value; and output control means for controlling discarding of the output data, or waiting of the output based upon the instruction issued from the synchronous control means. In accordance with the above-described arrangement, the synchronous control operation of reproducing each of the demultiplexed stream data is thinned not by the frame unit, but in the preset predetermined time period. As a result, the synchronous control operation can be simplified, so that the processing amount can be reduced.

In the present invention, the time period setting means sets the time period as a time duration, during which stream data of 1 frame is stored in the storage means. In accordance with the above-explained arrangement, since the reproducing time instant information is detected in the frame unit, the reproducing synchronous control operation can be carried out at a grain size of the frame unit.

In the present invention, the time period setting means sets the time period as a time duration, during which stream data having a predetermined data size is stored in the storage means. In accordance with the above-explained arrangement, since the reproducing time instant information is detected in the frame unit, the reproducing synchronous control operation can be carried out at a grain size of the predetermined data size.

In the present invention, the time period setting means sets the time period as a timer time period set by a timer. In accordance with this arrangement, since the reproducing time instant information is detected in the timer time period, the synchronous control operation of the reproducing operation can be carried out in a grain size of the predetermined time period.

In the present invention, the output control means discards the output data in the unit of the frame, and waits for the output based upon a timer time period. In accordance with this arrangement, the synchronous control operation can be simplified, and since the timer is employed, the process operation can be carried out in a simple manner.

In accordance with the present invention, the synchronous control operation of reproducing each of the demultiplexed stream data is thinned not by the frame unit, but in the preset predetermined time period. As a result, the synchronous control operation can be simplified, so that the processing amount can be reduced.

### BRIEF DESCRIPTION OF THE DRAWINGS

FIG. 1 is a diagram for schematically showing an arrangement of a decoding/reproducing apparatus according to an embodiment of the present invention.

FIG. 2 is a flow chart for describing operation sequences of a synchronous control apparatus of the decoding/reproducing apparatus according to the embodiment of the present invention.

FIG. 3 is a flow chart for describing operation sequences of an output data discarding/output waiting apparatus of the decoding/reproducing apparatus according to the embodiment of the present invention.

### DESCRIPTION OF THE PREFERRED EMBODIMENTS

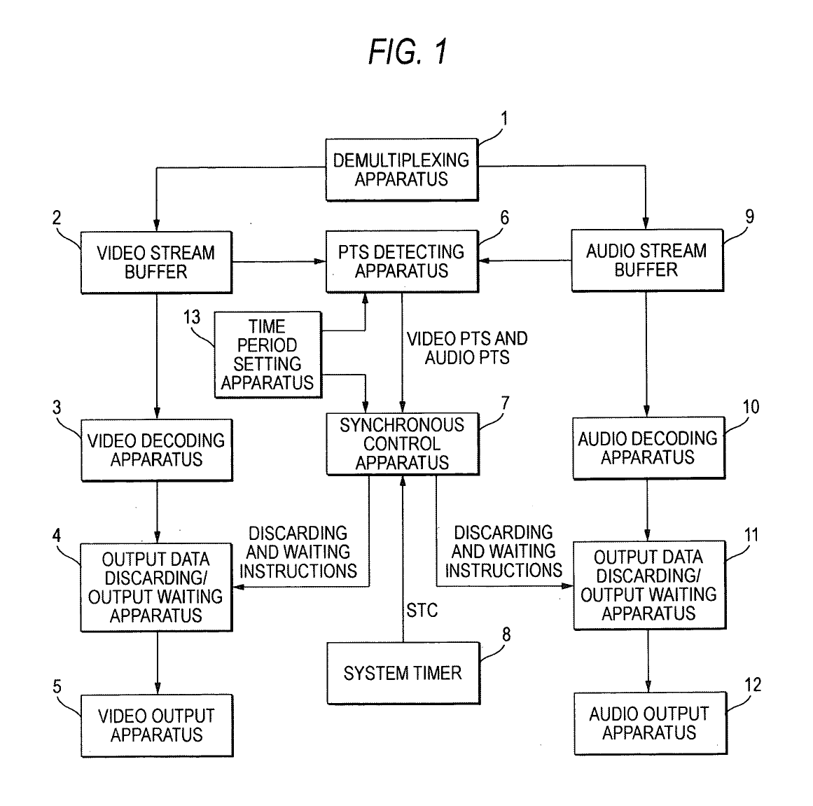

FIG. 1 is a diagram for schematically showing an arrangement of a decoding/reproducing apparatus according to an embodiment of the present invention. In the below-mentioned embodiment, a description is made of such a case that multiplexed stream data in which both audio stream data and video stream data have been multiplexed in accordance with an MPEG system is demultiplexed so as to be decoded and reproduced. It should be noted that the decoding/reproducing apparatus of the present invention can perform similar synchronous control operations even when sorts and quantities of stream data are changed.

The decoding/reproducing apparatus is provided with a demultiplexing apparatus 1, a video stream buffer 2, a video decoding apparatus 3, an output data discarding/output waiting apparatus 4, a video output apparatus 5, a PTS detecting apparatus 6, a synchronous control apparatus 10, a system timer 8, an audio stream buffer 9, an audio decoding apparatus 10, another output data discarding/output waiting apparatus 11, an audio output apparatus 12, and a time period setting apparatus 13.

The demultiplexing apparatus 1 functions as a demultiplexing means for demultiplexing both multiplexed audio stream data and the multiplexed video stream data. The video stream buffer 2 functions as a storage means for temporarily storing thereinto the video stream data demultiplexed by the demultiplexing apparatus 1. The video decoding apparatus 3 functions as a decoding means for reading out the video stream data stored in the video stream buffer 2 in the unit of a frame, and for decoding the read video stream data. The output data discarding/output waiting apparatus 4 functions as an output control means which discards output video data decoded by the video decoding apparatus 3 by 1 frame, for example, in the case of discarding, and which waits the output only for a designated time by way of a timer in the case of waiting operation in response to an instruction (will be explained later) instructed by the synchronous control apparatus 7. The video output apparatus 5 functions as an output means for outputting the output video data decoded by the video decoding apparatus 3 in the unit of a frame.

The PTS detecting apparatus 6 functions as a representation time stamp detecting means which analyzes stream data which are stored in the video stream buffer 2 and the audio stream buffer 9 so as to detect audio and video PTSs (presentation time stamps) in a predetermined time period. The detected PTSs are transferred to the synchronous control apparatus 7. It should also be understood that in the decoding/reproducing apparatus of the present invention, detections of PTSs may be carried out even in a predetermined timer period, a data size unit, or a frame unit by a time period setting apparatus (will be explained later). The data size unit corresponds to a time duration during which a predetermined data amount of stream data has been stored in the video stream buffer 2, or the audio stream buffer 9.

The synchronous control apparatus functions as a synchronous control means which compares the PTS detected by the PTS detecting apparatus 6 with an STC transferred from a system timer 8 (will be explained later), and instructs the output data discarding/output waiting apparatus 4 and 11 to discard output data, or to wait an output based upon a comparison result.

The system timer 8 functions a system time instant measuring means which acquires STC information from a counter timer which is set based upon PCR (Program lock Reference) information added to multiplexed stream data, and then, transfers the acquired STC information to the synchronous control apparatus 7. The audio stream buffer 9 functions as a storage means which temporarily stores thereinto the audio stream data demultiplexed by the demultiplexing apparatus 1. The audio decoding apparatus 10 functions as a decoding means which reads out the audio stream data stored in the audio stream buffer 9 in the unit of a frame so as to decode the read audio stream data. The output data discarding/output waiting apparatus 11 functions as an output control means which discards output audio data decoded by the audio decoding apparatus 10 by 1 frame, for example, in the case of discarding, and which waits the output only for a designated time by way of a timer in the case of waiting operation in response to an instruction instructed by the synchronous control apparatus 7. The audio output apparatus 12 functions as an output means for outputting the output audio data decoded by the audio decoding apparatus 10 in the unit of a frame. The time period setting apparatus 13 functions as a time period setting means which previously sets such a time period which is equal to a frequency at which the PTS detecting apparatus 6 detects PTS. In this embodiment, at a time instant when PTS is detected, a comparing operation between the PTS and the STC is carried out, and either a discarding instruction or a waiting instruction of output data is performed, so that this time period may be substantially equal to a time period of a synchronous control operation. Also, the PTS detecting apparatus 6 and the synchronous control apparatus 7 may be operated in independent time periods which are set by the time period setting apparatus 13.

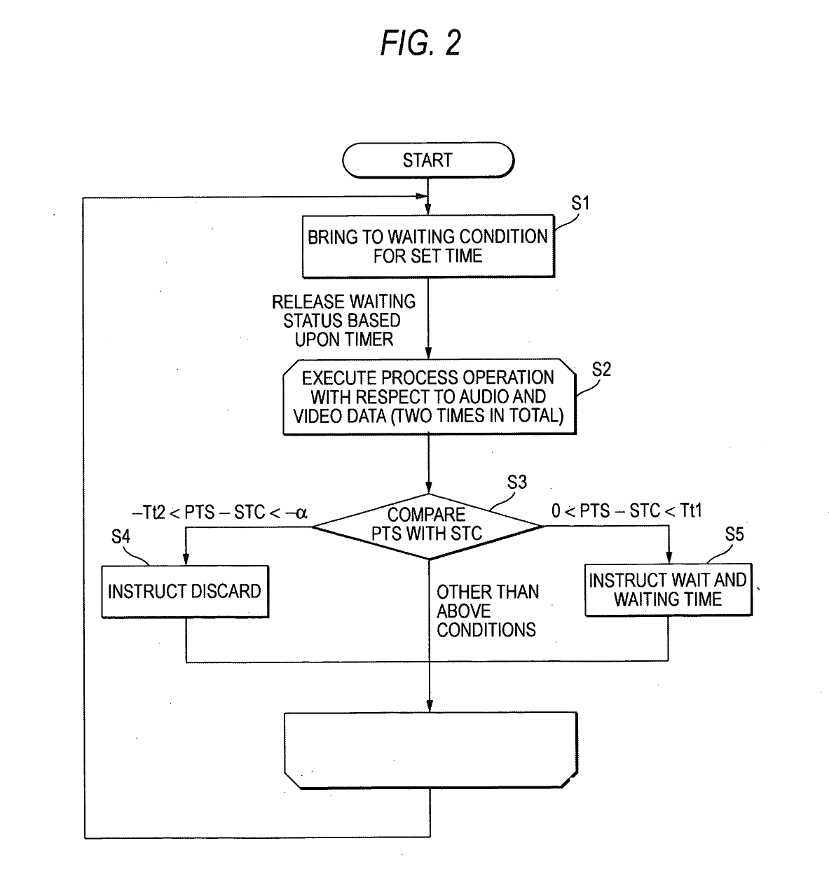

FIG. 2 is a flow chart for showing operation sequences of the synchronous control apparatus 7 employed in the decoding/reproducing apparatus according to the embodiment of the present invention. The synchronous control apparatus 7 is brought into a waiting condition only for a time period which is previously set by the time period setting apparatus 13. For example, in the case that the time period corresponds to a timer time which has been set to the timer, the synchronous control apparatus 7 is brought into the waiting condition only for a predetermined timer time (step S1). The waiting time is measured by a timer (not shown) provided in the decoding/reproducing apparatus, and if the set time has elapsed, then the waiting condition is released.

After the waiting condition has been released, the synchronous control apparatus 7 compares a PTS detected by the PTS detecting apparatus 6 with an STC (step S3). In such a case that 0<PTS−STC<Tt1 (note that symbol “Tt1” indicates preset positive value), the synchronous control apparatus 7 instructs a waiting time and a waiting operation (step S5). In the case that −Tt2<PTS−STC<−α (note that symbols “−Tt2” and “−α” indicate preset negative values), the synchronous control apparatus 7 instructs to discard stream data by 1 frame (step S4). On the other hand, when a comparison result is not made coincident with any of the above-described two conditions, the synchronous control apparatus 7 issues no instruction.

The above-described process operation is carried out with respect to each of the demultiplexed stream data (step S2). For example, in this embodiment, the above-explained process operation is carried out two times with respect to audio stream data and video stream data.

As previously explained, the comparing operation between the PTS and the STC, and either the discarding operation of the stream data or the output waiting operation of the stream data may be alternatively instructed in the unit of a data size and in the unit of a frame other than the time period by the timer.

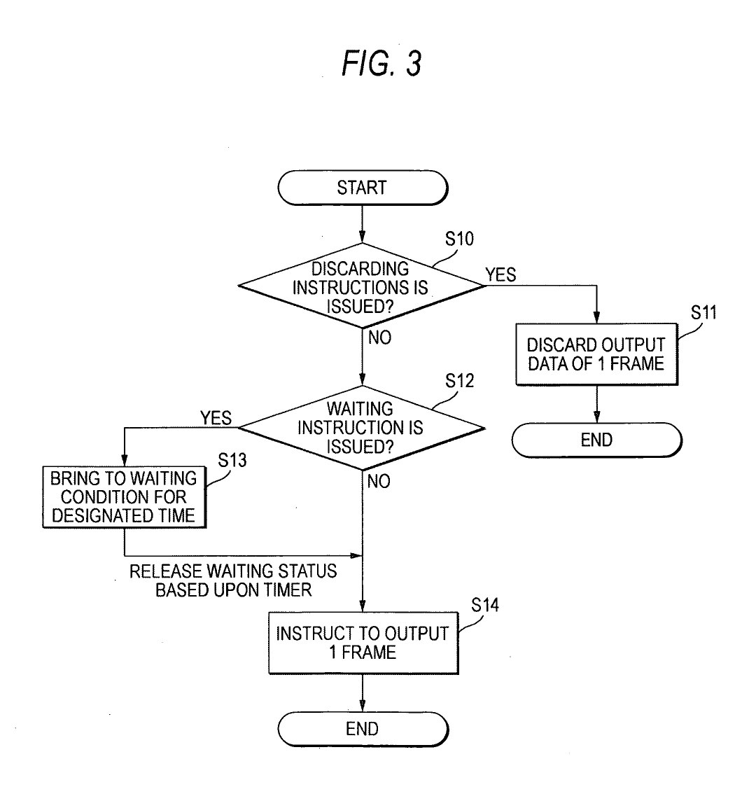

FIG. 3 is a flow chart for representing operation sequences of the output data discarding/output waiting apparatus 4 and 11 employed in the decoding/reproducing apparatus according to the embodiment of the present invention. The output data discarding/output waiting apparatus 4 and 11 judge as to whether or not the synchronous control apparatus 7 issues an instruction of discarding output data (step S10). When the discarding instruction is issued from the synchronous control apparatus 7, the output data discarding/output waiting apparatus 4 and 11 discard the output data by 1 frame, and then, accomplish the process operation (step S11).

On the other hand, in the case that the discard instruction is not issued from the synchronous control apparatus 7, the output data discarding/output waiting apparatus 4 and 11 judge as to whether or not a waiting instruction for an output is issued from the synchronous control apparatus 7 (step S12). When the waiting instruction is issued, the output data discarding/output waiting apparatus 4 and 11 wait the output only for the designated time (step S13). While a waiting time is measured by a timer (not shown) provided in the decoding/reproducing apparatus, if a set time has elapsed, then the waiting condition is released, and the output data discarding/output waiting apparatus 4 and 11 instruct the video output apparatus 5 and the audio output apparatus 12 to output the data of 1 frame, respectively (step S14). Also, in such a case that the discarding instruction of the output data and the waiting instruction of the output are not issued, the output data discarding/output waiting apparatus 4 and 11 instruct the video output apparatus 5 and the audio output apparatus 12 to output the data of 1 frame, respectively.

The decoding/reproducing apparatus of the present invention owns such an effect that since the synchronous control operation for reproducing the stream data decoded in the unit of the frame is carried out within the predetermined time period which has been preset, the data processing amount related to the synchronous control operation can be reduced. More specifically, the decoding/reproducing apparatus of the present invention is useful in reproducing operation of moving pictures by terminal apparatus which require to suppress data processing amounts, for instance, portable telephones and portable players.

What is claimed is:

1. A decoding/reproducing apparatus for decoding/reproducing multiplexed stream data which is formed by multiplexing a plurality of stream data arranged in the unit of a frame, to which reference time instant information and synchronous reproduction-purpose reproducing time instant information are added, comprising:
a demultiplexer, demultiplexing the multiplexed stream data to obtain a plurality of stream data;
a storage, storing thereinto the plurality of stream data demultiplexed by the demultiplexer;
a decoder, decoding the stream data stored in the storage in the unit of the frame;
an outputting unit, outputting output data decoded by the decoder in the unit of the frame;
a time period setter, previously setting a time period related to asynchronous control operation;
a reproducing time instant detector, detecting the synchronous reproduction-purpose reproducing time instant information from the stream data stored in the storage in the time period;
a system time instant measurer, measuring a system time instant based upon the reference time instant information;
a synchronous controller, which compares the reproducing time instant information with the system time instant information measured by the system time instant measurer, and which instructs to wait for an output in the case that a difference between a reproducing time instant and a system time instant is larger than 0, and is smaller than a preset positive value, and also which instructs to discard output data in the case that a difference between a reproducing time instant and a system time instant is defined within a range of a preset negative value; and
an output controller, controlling discarding of the output data, or waiting of the output based upon the instruction issued from the synchronous controller.

2. The decoding/reproducing apparatus as claimed in claim 1 wherein.
the time period setter sets the time period as a dime duration, during which stream data of 1 frame is stored in the storage.

3. The decoding/reproducing apparatus as claimed in claim 1 wherein:
the time period setter sets the time period as a time duration, during which stream data having a predetermined data size is stored in the storage.

4. The decoding/reproducing apparatus as claimed in claim 1 wherein:
the time period setter sets the time period as a timer time period set by a timer.

5. The decoding/reproducing apparatus as claimed in claim 1, wherein:
the output controller discards the output data in the unit of the frame, and waits for the output based upon a timer time period.
